(19) United States
(12) Patent Application Publication
(10) Pub. No.: US 2014/0379557 A1
(43) Pub. Date: Dec. 25, 2014

(54) VISUAL REPRESENTATION OF ACCOUNTS

(71) Applicant: International Business Machines Corporation, Armonk, NY (US)

(72) Inventor: Michael Sean Brown, Wahroonga (AU)

(21) Appl. No.: 13/922,312

(22) Filed: Jun. 20, 2013

(51) Int. Cl. G06Q 20/10; G06T 3/40

(52) U.S. Cl. CPC G06Q 20/10; G06T 3/40
USPC 705/39

(57) ABSTRACT

A method for visual representation of actual accounts which includes displaying by a display a plurality of visual account representations which visually represent the actual accounts and are linked to the actual accounts, the plurality of visual account representations changing shape when a transaction is performed with respect to the plurality of visual account representations; responsive to transaction input with respect to one of the visual account representations, changing shape by the display of the one visual account representation in proportion to the size of the transaction input; and responsive to the transaction input with respect to the one of the visual account representations, changing shape by the display of a second visual account representation in proportion to the size of the transaction input. Also disclosed is a computer program product for visual representation of accounts.

### BACKGROUND

The present invention relates to accounts such as business accounts and bank accounts, and more particularly, relates to a method for displaying such accounts which allows easy transfer from one account to another account and for establishing new accounts.

Traditionally banks have represented customer's finances as a series of bank accounts with a number of attributes. A single customer may have a credit card, a transaction account with an associated debit card, a mortgage, and a number of savings accounts. Each account has a fixed balance, and other attributes such as interest rate, bank fees, overdraft etc.

While funds are now more convenient to access, this representation of the customer's banking details is essentially the same as when banks were run on paper ledger systems. The customer can use modern systems such as Internet or phone banking to move funds between these different accounts, but flexibility is severely limited. If the customer has a new saving goal—such as the purchase of a car—and he or she wants to separate some funds from his or her daily transaction account, a new savings account needs to be opened and a trip to a physical bank branch or filling out online forms is often required.

### BRIEF SUMMARY

The various advantages and purposes of the exemplary embodiments as described above and hereafter are achieved by providing, according to a first aspect of the exemplary embodiments, a method for visual representation of actual accounts including: displaying by a display a plurality of visual account representations which visually represent the actual accounts and are linked to the actual accounts, the plurality of visual account representations changing shape when a transaction is performed with respect to the plurality of visual account representations; responsive to transaction input with respect to one of the visual account representations, changing shape by the display of the one visual account representation in proportion to the size of the transaction input; and responsive to the transaction input with respect to the one of the visual account representations, changing shape by the display of a second visual account representation in proportion to the size of the transaction input; wherein the method is performed on one or more computing devices.

According to a second aspect of the exemplary embodiments, there is provided a computer program product for visual representation of actual accounts, the computer program product including a non-transitory computer readable storage medium having computer readable program code embodied therewith. The computer readable program code including: computer readable program code configured to display a plurality of visual account representations which visually represent the actual accounts and are linked to the actual accounts, the plurality of visual account representations changing shape when a transaction is performed with respect to the plurality of visual account representations; responsive to transaction input with respect to one of the visual account representations, computer readable program code configured to change shape of the one visual account representation in proportion to the size of the transaction input; and responsive to the transaction input with respect to the one of the visual account representations, computer readable program code configured to change shape of a second visual account representation in proportion to the size of the transaction input.

### BRIEF DESCRIPTION OF SEVERAL VIEWS OF THE DRAWINGS

The features of the exemplary embodiments believed to be novel and the elements characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 illustrates a display such as in a tablet or smartphone and having visual representations of various banking products.

FIG. 2 illustrates the display of FIG. 1 showing various subaccounts established by a user.

FIG. 3 illustrates the display of FIG. 2 which has been modified in response to actions by the user.

FIG. 4 illustrates several methods by which subaccounts may be created in the display by the user.

FIG. 5 illustrates a display having different visual account representations for various subaccounts established by a user.

FIG. 6 illustrates a zoomed-in view of one of the subaccounts.

FIG. 7 is a block diagram illustrating an exemplary hardware environment for the exemplary embodiments.

### DETAILED DESCRIPTION

The exemplary embodiments have particular applicability to banking applications where a customer may desire easy, visual access to his/her accounts while also having the ability to form various subaccounts without having to contact the customer's banking institution first. The exemplary embodiments may also have applicability to other applications such as business applications where a business may need to visually manage its accounts and subaccounts. Other business applications may include, for example, stock control and spare parts logistics. For example, the business may want to visually display warehouse stock or spare part quantities, customer accounts, vendor accounts, expense accounts, capital accounts, purchase orders and the like.

The remainder of the description will focus on banking applications for the exemplary embodiments but it should be understood that the exemplary embodiments have applicability to applications other than banking.

The exemplary embodiments provide a new user experience to the customer, while only requiring minimal changes to a bank's back-end systems. Rather than a series of textual and numeric descriptions of funds and account structure, all the banking products are provided in a single summary screen and the user may interact with the banking products using a display having a pointing device or touch interface.

According to the exemplary embodiments, bank accounts (or modern equivalents) may be created or removed dynamically behind the scenes in response to user interaction, allowing the end user to put money aside for specific purposes. Real-world objects such as credit cards and debit cards may be linked to funds in real-time based on user interaction to allow for controlled spending.

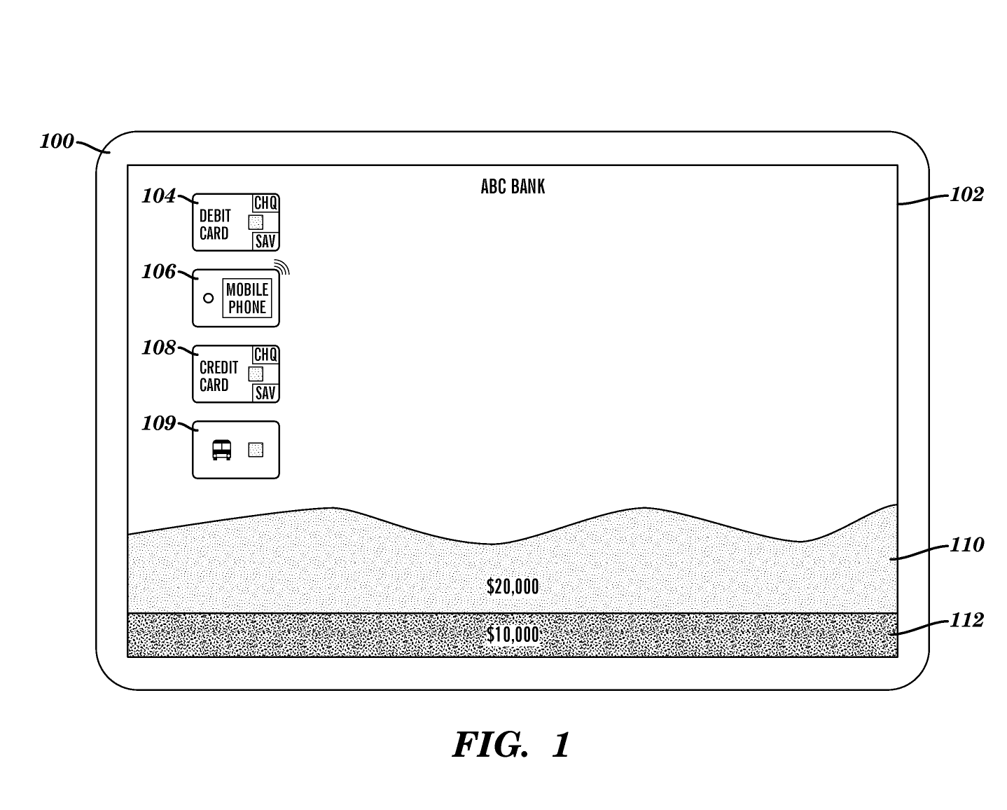

Referring to the Figures in more detail, and particularly referring to FIG. 1, there is illustrated a device 100 having a display 102. The device 100 is preferably a tablet or smartphone but may also include devices such as a laptop computer or personal computer.

The display 102 shows visual representations of various banking products that a customer may have at a banking institution, conveniently labeled as ABC Bank. Banking products hereafter are referred to more generally as accounts and subaccounts.

Display 102 illustrates various debit cards and credit cards that the customer may have with ABC Bank such as debit card 104, mobile device 106, credit card 108 and public transport pass 109. Each of the debit card 104 and credit card 108 may have a check (“CHQ”) function and a savings (“SAV”) function so that amounts debited or charged may be taken from the user's checking account or savings account. Also illustrated in display 102 are liquid assets 110 which may be illustrated by a visual representation, for example, of a liquid. Liquid assets 110 include accessible monetary funds (cash) that the customer may have in an account with ABC Bank. For purposes of illustration and not limitation, liquid assets 110 may for example comprise $20,000 in monetary funds. The level of liquid assets 110 may rise and fall as monetary funds are added or subtracted from liquid assets 110. Monetary funds may be added to liquid assets 110 as the customer may see fit such as when the customer receives his salary. Monetary funds may be subtracted from liquid assets 110 when, for example, monetary funds are moved to other accounts and subaccounts.

Underneath liquid assets 110 may be a non-liquid layer or layers 112 which may include assets such as certificates of deposits, stocks and other investments that are not as readily accessible and usable as monetary funds.

Not presently shown in FIG. 1 are various subaccounts that the customer may have or desire to have with ABC Bank. These various subaccounts may receive monetary funds from liquid assets 110 and/or may be linked to debit card 104, mobile device 106, credit card 108, or public transport contactless payment systems 109.

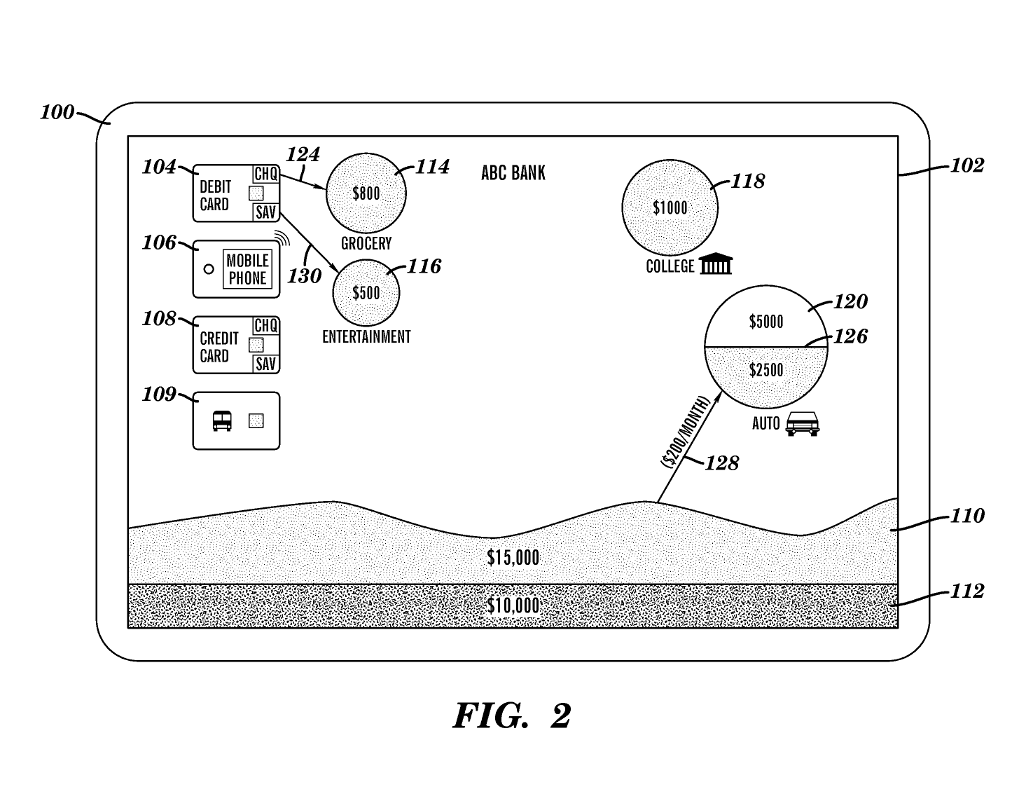

Referring now to FIG. 2, the customer has set up various subaccounts which may be funded from the customer's liquid assets 110. The bookkeeping for these various subaccounts is handled dynamically behind the scenes by ABC Bank and the customer may be unaware that a new account number (or modern equivalent) has been created and assigned for some or all of the various subaccounts. It is up to ABC Bank to determine how these various subaccounts are handled by ABC Bank. There is no need for the customer to travel to a bank branch to open several different accounts corresponding to the various subaccounts shown in FIG. 2. Liquid assets 110 and the various subaccounts may comprise one account established with ABC Bank with the exception that the customer may establish the subaccounts in near real-time as the customer may desire without interacting with ABC Bank via any means other than the described interface illustrated by display 102.

The customer may set up multiple accounts and related subaccounts on the display at the same time. The customer in addition may readily move monetary funds within the same account as well as across different accounts and subaccounts.

The display 102 provides a convenient customer interface for the customer to effortlessly interact with all of his/her accounts and establish subaccounts, all without having to visit a bank branch. ABC Bank handles all of the bookkeeping transparent to the customer.

An account may be formally established by the user with ABC Bank by, for example, visiting the bank and filling out paperwork to establish the account. The user may establish one or more subaccounts of each user account by setting up the subaccounts and displaying the subaccounts on the display 102. ABC Bank intervention is not required to set up and display the subaccounts. The various subaccounts shown in FIG. 2 are for purposes of illustration only and are not meant to be limiting in any way. The means to set up the various subaccounts will be discussed hereafter.

It is noted that the level of liquid assets 110 in FIG. 2 has decreased to $15,000 as monetary funds were removed from liquid assets 110 and moved to the various subaccounts.

The various subaccounts may include subaccounts to set aside monetary funds for expenses such as groceries 114 and entertainment 116. Other subaccounts may be set up to save for college 118 or a new car 120. Still other subaccounts, for example, may be set up to pay for an auto loan for a vehicle that the customer has already purchased.

For purposes of illustration and not limitation, grocery subaccount may have $800, entertainment subaccount 116 may have $500 and college fund subaccount 118 may have $1000 in savings. The savings account for auto 120 has $2500 in monetary funds and $200 may be transferred automatically from liquid assets 110 every month to save for the new vehicle. All of the foregoing amounts for the various subaccounts have been subtracted from the liquid assets 110, resulting in a $5000 decrease in liquid assets 110.

The visual representations for each of the various subaccounts may be chosen by the customer, by the ABC Bank or by default based on the characteristics of the subaccounts.

Grocery subaccount 114 and entertainment subaccount 116 may be formed as bubbles. The size of the bubbles may be proportional to the monetary funds within the bubbles. Thus, grocery subaccount 114 has a bubble visual representation that is larger than the bubble visual representation of the entertainment subaccount 116 due to the greater amount of monetary funds within grocery subaccount 114. It is noted that the CHQ function of debit card 104 is linked 124 to grocery subaccount 114 and the SAV function of debit card 104 is linked 130 to entertainment subaccount 116 such that the debit card 104 may be used to pay for these expenditures. A rule may be set up such that when the amount spent on groceries meets or exceeds the amount set aside for groceries, further expenditures on groceries is halted until the grocery subaccount is replenished. A similar rule may be set up for the entertainment subaccount. In one exemplary embodiment, it may be that actual monetary funds of $800 and $500 have not actually been transferred to the grocery subaccount 114 and the entertainment subaccount 116, respectively, but that debit card 104 is authorized to spend up to the designated amount for each of the grocery subaccount 114 and entertainment subaccount 116. Other rules may be set up, for example, based on the type of transaction or vendor classifications.

Debit card 104, mobile device 106 and credit card 108 may be linked to more than one account such as a checking account, savings account and credit account. Each of these attributes may be shown on display 102 as the need arises.

College subaccount 118 functions as a savings account and has a visual representation of a college building adjacent to the bubble visual representation. The user may add monetary funds to college subaccount 118 periodically or increase the funds in the account by various means discussed hereafter.

The auto subaccount 120 may be used to save for a new automobile or other vehicle. Auto subaccount 120 has been set with a value of $5000 as a target to save for the new vehicle. The auto subaccount 120 is in the form of a bubble and contains $2500 in monetary funds which have already been saved towards the target of $5000. The size of the bubble for auto subaccount 120 may be chosen to be proportional to the amount of monetary funds in the auto subaccount 120, which is the case as shown in FIG. 2, or may be chosen to be proportional to the amount of the vehicle that is being saved for, $5000 in this case. The auto subaccount 120 may also contain a level indicator 126 visually representing how much has been saved towards the goal of purchasing a new vehicle.

The auto subaccount 120 also may have a rule defined 128 which allocates, for example, $200 from the liquid funds when a condition is met—in this case monthly after the customer's salary has been paid. The way this rule is defined is described thereafter. The $200 monthly amount has been added as indicia to the auto subaccount 120.

While the size of the visual representations of the various subaccounts has been set in FIG. 2 to be proportional to the amount of monetary funds in the subaccounts, the visual representations of the various subaccounts may also change as amounts of monetary funds are added to or subtracted from the various subaccounts.

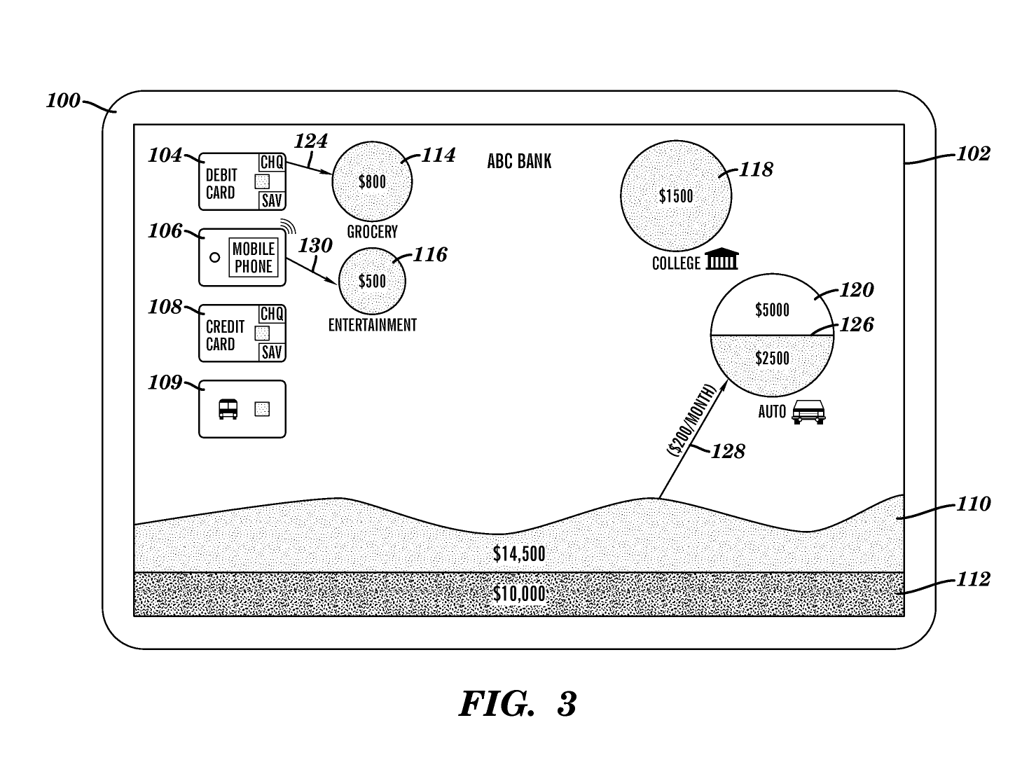

Referring now to FIG. 3, an additional $500 has been moved from the liquid funds 110 to the college subaccount 118. As a result of this transfer, the size of the visual representation of the college subaccount 118 has increased in size and the size of the visual representation of the liquid funds 110 has decreased in size. FIG. 3 also illustrates a change in the link to the entertainment subaccount 116. In FIG. 2, the entertainment subaccount 116 was linked to the SAV function of the debit card 104. In FIG. 3, entertainment subaccount 116 is now linked to the mobile device 106 by link 130. The change in the link may be done in one way by placing the user's finger on the link and moving it from debit card 104 to mobile device 106.

In addition to the visual representations being able to be made larger and smaller, they may be set in motion. For example, in one embodiment, the liquid assets 110 may be shown as a liquid that sloshes when the device 100 is moved. In a tablet or smartphone, the user may simply tilt the device 100 back and forth to cause the liquid funds 110 to slosh around as if it were a liquid. Graphical animations such as realistic movement based on the device's tilt and movement sensors or touch input may further enhance the user experience with respect to the visual representations such as liquid assets 110. For non-liquid layer or layers 112, graphical animations for these non-liquid layers 112 based on movement or touch input could still apply, but a higher degree of perceived viscosity, or “stickiness” could indicate to the customer that they are unable to interact as easily with these assets. Subaccount bubbles could be moved and wobble like soap bubbles or suspended liquid, and can be destroyed by swiping a finger through them, allowing an animation of the contained liquid to fall back into the liquid funds pool. Interest paid on account balances could be shown as rain or water drops, and so forth.

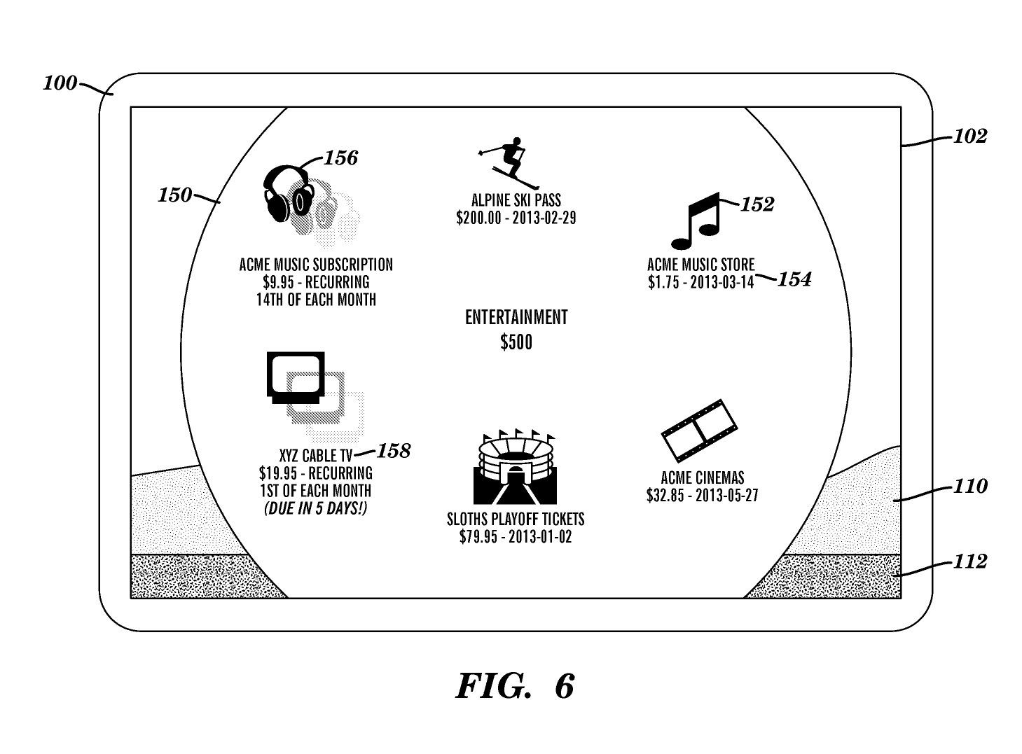

It is within the scope of the exemplary embodiments that graphical elements such as but not limited to visual representations of individual subaccounts may be zoomed-in by a user action such as double-tapping. Referring to FIG. 6, the zoomed-in expanded view 150 of a graphical element (in this case, entertainment subaccount 116) may take a dominant portion of the display, and may show more detail such as a record of past payments, or future recurring payments. FIG. 6 shows a zoomed-in view of past payments that have been deducted from the entertainment subaccount, such as a music purchase 152 and the details of that payment 154. Regular (recurring) account debits such as a music subscription 156 may also be represented visually, for example as multiple fading icons. FIG. 6 also shows a recurring payment 158 for a cable TV service with an additional warning that the payment is due in five days. Long pressing or right clicking on these payment icons could also provide additional details, or options such as cancelling recurring payments.

While the example in FIG. 6 shows payments in a free-form “cloud” arrangement with circular scrolling, such information may equally be represented by “film strip” style representation in chronological order or any other method of representing this data graphically and interactively.

While the entertainment subaccount bubble is shown in FIG. 6 by way of example, similar methods could be applied to any graphical element. For example expanding the credit card visual representation 108 from FIG. 1 could display additional details such as card expiration date, or geo location information for where it was used. Investments and loans may be interacted with in a similar way.

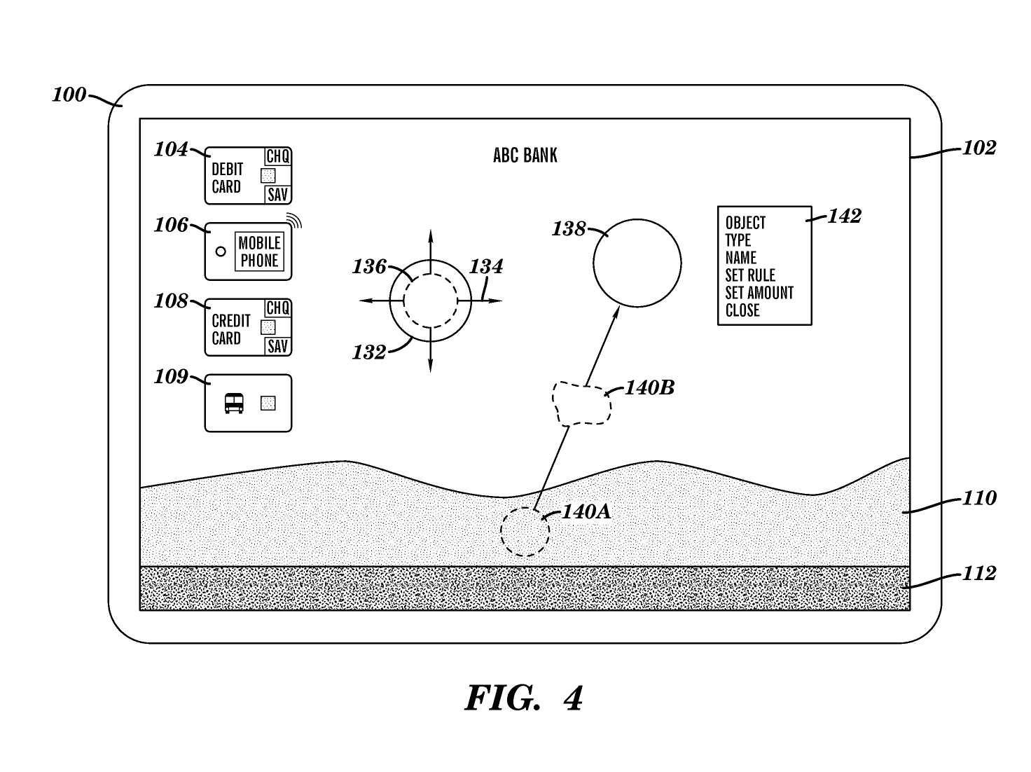

Referring now to FIG. 4, various methods are shown for adding and modifying the visual representations of the subaccounts. In one method, a user may long press on the display 102 to create an empty bubble 132—for example for a savings goal. The user may increase or decrease the size of the bubble 132 by pinching the fingers in an outward or inward motion respectively. Arrows 134 indicate an outward motion to increase the size of the bubble 132. Bubble 136 shown in dotted lines indicates the bubble 132 that has been sized smaller. The user may adjust the size of the bubble to be proportional to the monetary funds that the bubble represents. The user may create an “empty” bubble by long-pressing on the screen or dragging a bubble from the side or a tool-bar. These new bubbles may be used for savings goals (for example, saving for a new car) and may be resized by pinching or manually editing attributes. Alternatively, the user may drag some of the liquid funds to create a “full” bubble for budgeting purposes. The “full” bubble may be created with a default amount, and the user could pinch to resize or manually edit the bubble attributes.

FIG. 4 further illustrates a second method of creating bubbles or other visual representations of the subaccounts. In one exemplary embodiment, the user may press a finger in liquid assets 110 to create a wobbly bubble 140A and drag it away from liquid assets 110 which drags a piece 140B of monetary funds from liquid assets 110 to create bubble 138 with a certain amount of monetary funds. Bubble 138 would be created containing either a default amount of funds (for example, $100) or use an algorithm to estimate the initial value based on available funds and size of existing and previously created subaccounts. Liquid assets 110 would then become smaller by an amount proportional to the amount of funds moved to bubble 138. The funds assigned to bubble 138 could then be adjusted by methods described hereafter.

In another exemplary embodiment, the user may, for example, long press, or right click on the bubble 138 and a dialog box 142 would open up. The dialog box 142 may have functions such as “object” to choose the shape(e.g., bubble, car, building, etc.) of the visual representation of the subaccount, “type” to indicate saving, expenses, loan, etc., “name” to name the subaccount such as “grocery” or “entertainment”, “set rule” to select or make a rule such as adding a set amount to a subaccount every month, “set amount” to set the amount added to the subaccount and “close” to close the dialog box 142. The dialog box 142 may include other functions as well.

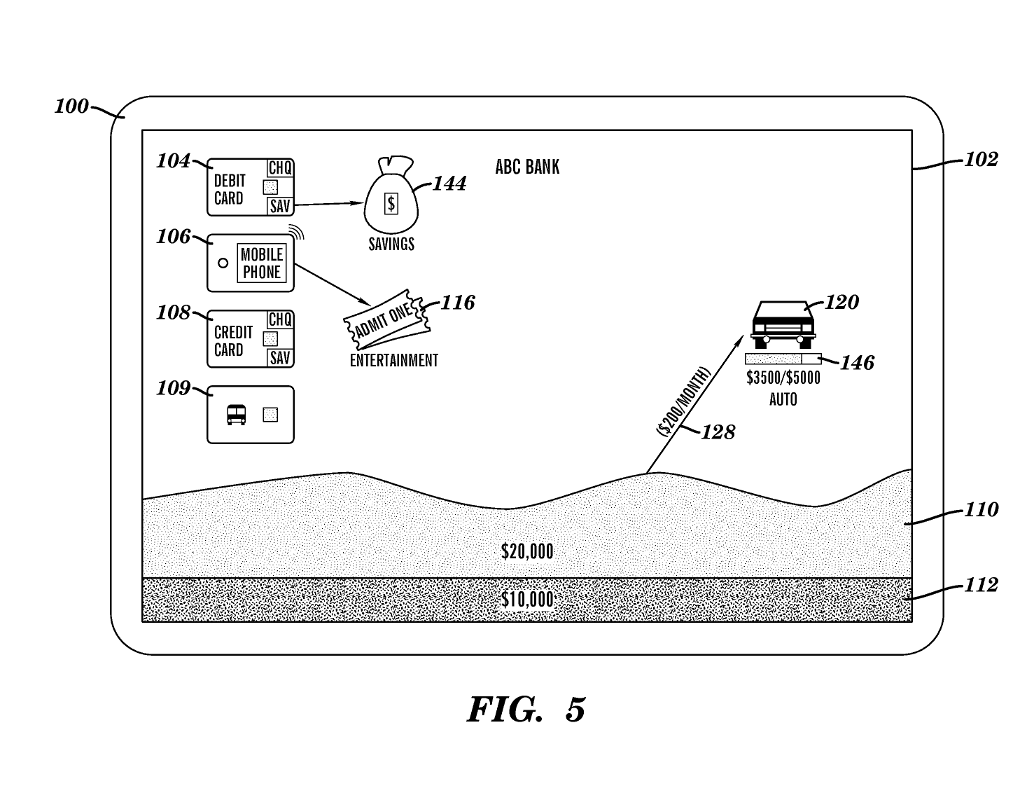

FIG. 5 demonstrates that it should be understood that the visual representations described herein are only illustrations of what they visual representations may be and are not meant to be limiting in any way. It is contemplated that any graphical symbol or clip art may be used as the visual representation provided that it is capable of interacting with the other visual representations as described herein. For example, a new saving visual representation 144 has been created which is linked to the SAV function of debit card 104. As another example, the entertainment bubble 116 shown in FIGS. 2 and 3 now appears as a ticket visual representation. As a further example, the auto bubble 120 in FIGS. 2 and 3 now appears as an auto visual representation with a graphical bar 146 indicating how much has been saved toward the ultimate goal of a new vehicle.

The visual representation should be able to expand or contract or otherwise change shape as the visual representation is being added to or subtracted from, respectively, for example, as in the case of monetary funds being added to or subtracted from the visual representation. The visual representation preferably should also be dependent upon another visual representation such as when a bubble expands by adding monetary funds to it while the liquid assets visual representation shrinks.

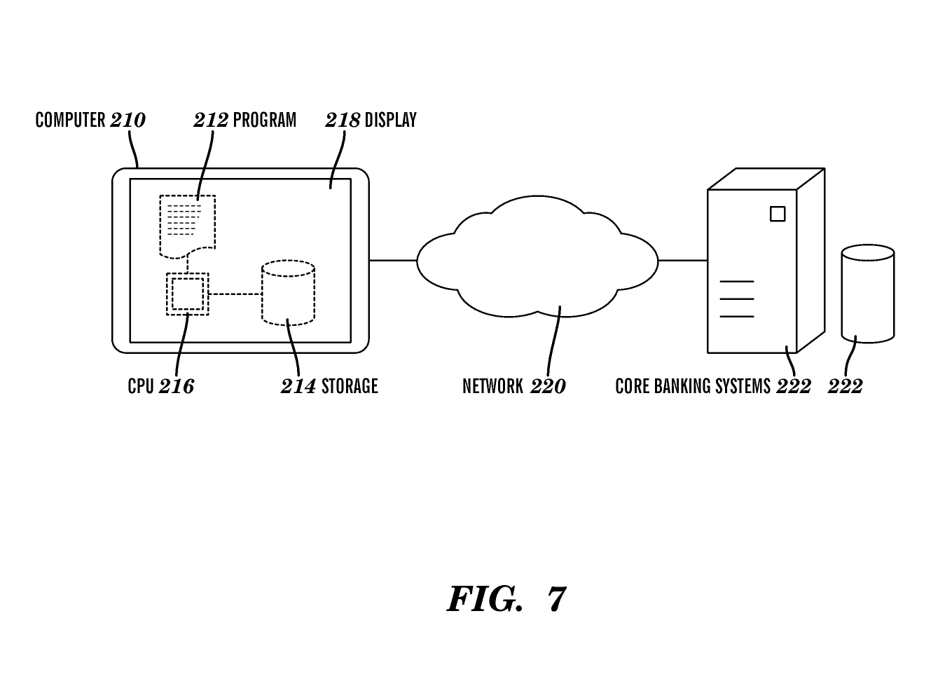

The computing devices implementing the exemplary embodiments may be a general-purpose computer or a special purpose computing device such as a hand-held computer. FIG. 7 is a block diagram that illustrates one exemplary hardware environment of the computing devices. The exemplary embodiments may be implemented using a computer 210 (for example, a tablet) having a display 218 and comprised of microprocessor means 216, random access memory (RAM) (not shown), read-only memory (ROM)(not shown) and other components. The computer 210 may be a tablet, smartphone, personal computer, server, mainframe computer, hand-held device or other computing device. Resident in the computer 210, or peripheral to it, may be a storage device 214 of some type such as a hard disk drive, flash drive, floppy disk drive, CD-ROM drive, tape drive or other storage device.

Computer 210 may be connected by network 220 to core banking systems 222. Core banking systems 222 may perform the function of a bank's back-end-system.

Generally speaking, the software implementation of the exemplary embodiments, program 212 in FIG. 7, may be tangibly embodied in a computer-readable medium such as one of the storage devices 214 mentioned above. The program 212 may comprise instructions which, when read and executed by the microprocessor of the computer 210, may cause the computer 210 to perform the steps necessary to execute the steps or elements of the exemplary embodiments.

As will be appreciated by one skilled in the art, aspects of the exemplary embodiments may be embodied as a system, method, service method or computer program product. Accordingly, aspects of the exemplary embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the exemplary embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible or non-transitory medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the exemplary embodiments may be written in any combination of one or more programming languages, including an object oriented programming language such as Java, Smalltalk, C++ or the like and conventional procedural programming languages, such as the “C” programming language or similar programming languages or even Microsoft Excel/Access. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the exemplary embodiments have been described above with reference to flowchart illustrations and/or block diagrams of methods, apparatus (systems) and computer program products according to the exemplary embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and/or block diagrams in the Figures illustrate the architecture, functionality, and operation of possible implementations of systems, methods, service methods and computer program products according to the exemplary embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be apparent to those skilled in the art having regard to this disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. A method for visual representation of actual accounts comprising:
displaying by a display a plurality of visual account representations which visually represent the actual accounts and are linked to the actual accounts, the plurality of visual account representations changing shape when a transaction is performed with respect to the plurality of visual account representations;
responsive to transaction input with respect to one of the visual account representations, changing shape by the display of the one visual account representation in proportion to the size of the transaction input; and
responsive to the transaction input with respect to the one of the visual account representations, changing shape by the display of a second visual account representation in proportion to the size of the transaction input;
wherein the method is performed on one or more computing devices.

2. The method of claim 1 wherein changing shape comprises becoming larger if the transaction input increases an amount of the actual account linked to the visual account representation and becoming smaller if the transaction input decreases an amount of the actual account linked to the visual account representation.

3. The method of claim 2 wherein the display of the second visual account representation becomes smaller when the display of the one visual account representation becomes larger while the display of the second visual account representation becomes larger when the display of the one visual account representation becomes smaller.

4. The method of claim 1 further comprising avoiding changing shape of a third visual account representation.

5. The method of claim 1 further comprising displaying by the display at least one of a debit card, a credit card, a mobile device and a public transport pass and linking the at least one of the debit card, credit card, mobile device and public transport pass to at least one of the visual account representations.

6. The method of claim 1 wherein displaying includes responsive to selecting a format for each of the plurality of visual account representations, displaying the plurality of visual account representations in the format selected.

7. The method of claim 1 wherein displaying includes responsive to selecting by a user a type of account for each of the plurality of visual account representations, displaying the plurality of visual account representations according to the account selected by the user for each of the plurality of visual account representations.

8. The method of claim 1 wherein each visual account representation is liked to a separate actual account.

9. The method of claim 1 wherein the one visual account representation represents a savings account, an expense account, a loan account or an investment account.

10. The method of claim 1 wherein the second visual account representation represents a pool of liquid assets.

11. The method of claim 1 wherein responsive to selecting one of the visual account representations, further comprising zooming-in on one of the visual account representations to expand the one visual account representation and display additional information about the one visual account representation.

12. The method of claim 2 wherein responsive to dragging in the display a part of the second visual account representation to the one visual account representation, changing shape of the one visual account representation by making it larger and changing shape of the second visual account representation by making it smaller.

13. The method of claim 1 wherein responsive to selecting the one of the visual account representations, displaying by the display a dialog box.

14. A computer program product for visual representation of actual accounts, the computer program product comprising;
a non-transitory computer readable storage medium having computer readable program code embodied therewith, the computer readable program code comprising:
computer readable program code configured to display a plurality of visual account representations which visually represent the actual accounts and are linked to the actual accounts, the plurality of visual account representations changing shape when a transaction is performed with respect to the plurality of visual account representations;
responsive to transaction input with respect to one of the visual account representations, computer readable program code configured to change shape of the one visual account representation in proportion to the size of the transaction input; and
responsive to the transaction input with respect to the one of the visual account representations, computer readable program code configured to change shape of a second visual account representation in proportion to the size of the transaction input.

15. The computer program product of claim 14 wherein computer readable program code configured to change shape comprises computer readable program code configured to make the visual account representation larger if the transaction input increases an amount of the actual account linked to the visual account representation and computer readable program code configured to make the visual account representation smaller if the transaction input decreases an amount of the actual account linked to the visual account representation.

16. The computer program product of claim 15 wherein computer readable program code configured to change the shape of the second visual account representation comprises computer readable program code configured to make the second visual account representation smaller when the one visual account representation becomes larger while computer readable program code configured to change the shape of the second visual account representation comprises computer readable program code configured to make the second visual account representation larger when the one visual account representation becomes smaller.

17. The computer program product of claim 14 wherein displaying includes responsive to selecting by a user a format for each of the plurality of visual account representations, displaying the plurality of visual account representations in the format selected by the user for each of the plurality of visual account representations.

18. The computer program product of claim 14 wherein computer readable program code configured to display includes responsive to selecting a type of account for each of the plurality of visual account representations, computer readable program code configured to display the plurality of visual account representations according to the account selected.

19. The computer program product of claim 14 wherein each visual account representation is linked to a separate actual account.

20. The computer program product of claim 15 wherein responsive to dragging in the display a part of the second visual account representation to the one visual account representation, computer readable program code configured to change shape of the one visual account representation by making it larger and computer readable program code configured to change shape of the second visual account representation by making it smaller.
